(19) United States
(12) Patent Application Publication
(10) Pub. No.: US 2014/0318332 A1
(43) Pub. Date: Oct. 30, 2014

(54) Facial Hair Shaver With Built-in Facial Hair Pattern Guides

(71) Applicant: Hasam Eljaouhari, Katy, TX (US)

(72) Inventor: Hasam Eljaouhari, Katy, TX (US)

(21) Appl. No.: 13/874,394

(22) Filed: Apr. 30, 2013

(51) Int. Cl. B26B 21/40

(52) U.S. Cl. CPC B26B 21/4012; B26B 21/4081
USPC 83/13; 30/42

(57) ABSTRACT

A shaving apparatus comprising: a canopy with a nose guard and chin guard; at least one cutting mechanism disposed on a track within the canopy, wherein the track is configured to define the outline of a beard style; and a motor for (a) operating the cutting mechanism(s) and (b) shifting the position of the cutting mechanism(s) around the track. The apparatus may be positioned utilizing the canopy's features. Nose and chin guards may be spring mounted and adjustable to allow for various hair patterns and shapes. The cutting mechanisms may be spring mounted rotary blades that are pressed against the user's face.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

This invention is in the field of guarded or guided facial hair trimmers.

2. Background of the Invention

A beard is a grouping or groupings of facial hair that grow on the chin, upper lip, cheeks or neck of male humans. Throughout time, beard sporting males have been attributed with various qualities such as wisdom, sexual virility or masculinity. In modern times, various beard styles have developed as elements of fashion or non-verbal expression. Exemplary styles include: a mustache, which is defined by a tuft of hair on the upper lip of an otherwise clean shaved face; a goatee, which is defined as a tuft of hair on the chin of an otherwise clean shaved face; and a Van Dyke, which is defined as a mustache plus goatee on an otherwise clean shaved face. In modern parlance, the term goatee may refer to a goatee or a Van Dyke beard style.

In view of constantly growing facial hair, men are occasionally desirous of either repeating a particular beard style or changing their beard to a new style. Usually, repeating or changing a beard style is accomplished by free hand grooming of the beard using a shaver. Problems arise in free hand grooming because untrained beard groomers ordinarily cannot consistently (a) repeat an old beard style or (b) arrive at a desired new beard style from a preexisting one. Thus, a need arises for apparatus and related methods of consistently accomplishing a desired new or old beard style of a wearer.

In view of the forgoing, various guards and stencils exist, whether alone or in combination, for controlling the length and shape of facial hair tufts that compose a beard. For example, U.S. Pat. No. 6,655,389, U.S. Pat. No. 8,082,927, U.S. Des. Pat. No. D662258, U.S. Pub. Pat. App. No. 2009/0223530, and P.C.T. Pub. App. No. WO2010/134794 disclose various embodiments of stencils or guides for facial hair shavers. However, such known stencils/guides are not adequately suited for grooming all beard styles. First, many of the devices are not adapted to guard facial features that might otherwise be exposed to injury by hair cutting razors. Second, all of the devices do not have built-in razors so that the same must used in connection with a non-stationary and free-hand razor. Finally, none of the devices feature adjustment mechanisms for altering the stencil or guard to the particular face of a user. Thus, a need still exists for apparatus and related methods of consistently accomplishing a desired new or old beard style of a wearer without the drawbacks of known stencils or guides.

### SUMMARY OF THE INVENTION

Accordingly, it is an object of the present invention to provide apparatus and related methods of consistently accomplishing a desired new or old beard style. It is another object of the present invention to provide such apparatus and related methods in a manner that protects facial features that are otherwise exposed to injury by razors. Yet still, it is an object of the present invention to disclose such apparatus and related methods wherein the apparatus have built in razors with adjustment mechanisms for adapting facial hair patterns to the particular face or preference of a user.

In one embodiment, the disclosed apparatus comprises: a canopy with a nose guard and chin guard; at least one cutting mechanism disposed on a track within the canopy, wherein the track is configured to define the outline of a beard style; and a motor for (a) operating the cutting mechanism(s) and (b) shifting the position of the cutting mechanism(s) around the track. In operation: (1) the apparatus may be stagnantly placed over the mouth area so that the nose guard is positioned beneath the nostrils of a user and so that the chin guard is placed (or cupped) against the user's chin; (2) the motor may be turned-on whereby the cutting mechanism(s) operate while traversing the track to shape the beard style; and (3) the motor may continue to run so that the cutting mechanism(s) may repeatedly move back and forth along the track until the beard style is completed. In a preferred mode of operation, the track may be adjusted to fit the contours and size of the user's face. In one embodiment, the nose and chin guards may be preferably spring mounted and adjustable so that depth of the shape may be adjusted between a clean shave and various other facial hair lengths. In yet another embodiment, the cutting mechanisms may be defined by three spring mounted rotary blades on a spring mounted track, wherein the rotary blades may be pressed against the users face. In other embodiments, different spring-mounted cutting mechanisms, such as straight razors or lasers, may be utilized along the track.

### BRIEF DESCRIPTION OF THE FIGURES

Other objectives of the invention will become apparent to those skilled in the art once the invention has been shown and described. The manner in which these objectives and other desirable characteristics can be obtained is explained in the following description and attached figures in which:

FIG. 1A is a perspective view of a beard styling apparatus;

FIG. 1B is a right side view of beard styling apparatus;

FIG. 2 is a front view of a the beard styling apparatus;

FIG. 3 is a left-side view of the beard styling apparatus;

FIG. 4 is a back view of the beard styling apparatus;

FIG. 5 is an operational display of the back view of the beard styling apparatus;

FIG. 6 is an environmental view of the beard styling apparatus;

FIG. 7 a schematic diagram showing blades and a track positioned on a face;

FIGS. 8A & 8B is another schematic diagram showing a track positioned on a face;

FIG. 9 is yet another schematic diagram showing a track positioned on a face;

FIG. 10 is an operational and schematic view of blades and a track positioned on a face;

FIG. 11 is a perspective view of the track as positioned on a face;

FIG. 12 is a side view of the track;

FIG. 13 is an alternate embodiment of the beard styling apparatus;

FIG. 14 is an operation display of the apparatus of FIG. 13;

FIG. 15 is another embodiment of the beard styling apparatus; and,

FIG. 16 is an operational display of the apparatus of FIG. 15.

It is to be noted, however, that the appended figures illustrate only typical embodiments of the disclosed apparatus and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed are apparatus and related methods of consistently accomplishing a desired new or old beard style. The disclosed apparatus and related methods accomplish said beard styles in a manner that protects facial features which would otherwise be exposed to injury by hair cutting mechanisms. Yet still, the disclosed apparatus have built in razors with adjustment mechanisms for adapting facial hair patterns to the particular face or preference of a user.

In general, the disclosed apparatus comprises: a canopy that houses (i) a nose guard for supporting and aligning the apparatus to the nostrils and upper lip of a user, (ii) a chin guard for stabilizing and supporting the apparatus to the chin of the user, and (iii) a track that supports at least one cutting mechanism, wherein the track is configured to define the outline of a beard style; and a motor for (a) operating the cutting mechanism(s) and (b) shifting the position of the cutting mechanism(s) along the track. The more specific features of the apparatus are further disclosed in connection with the figures.

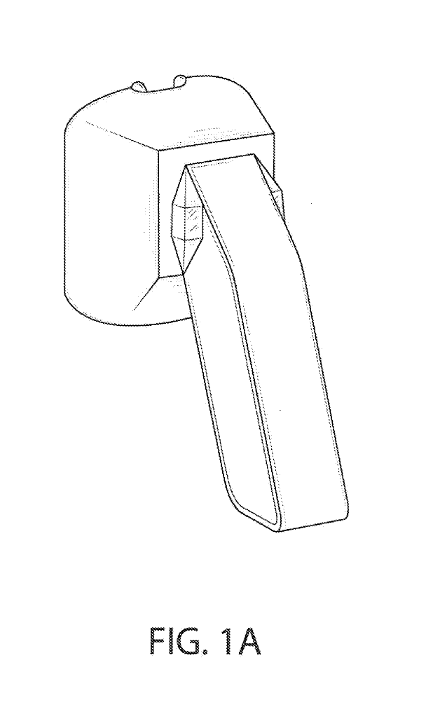

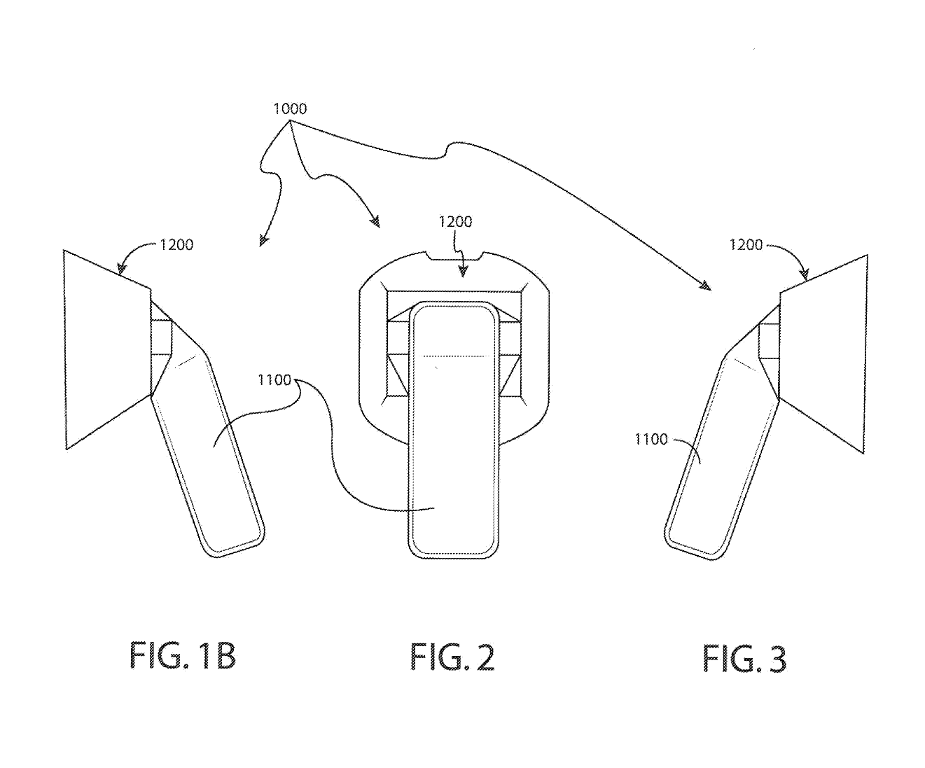

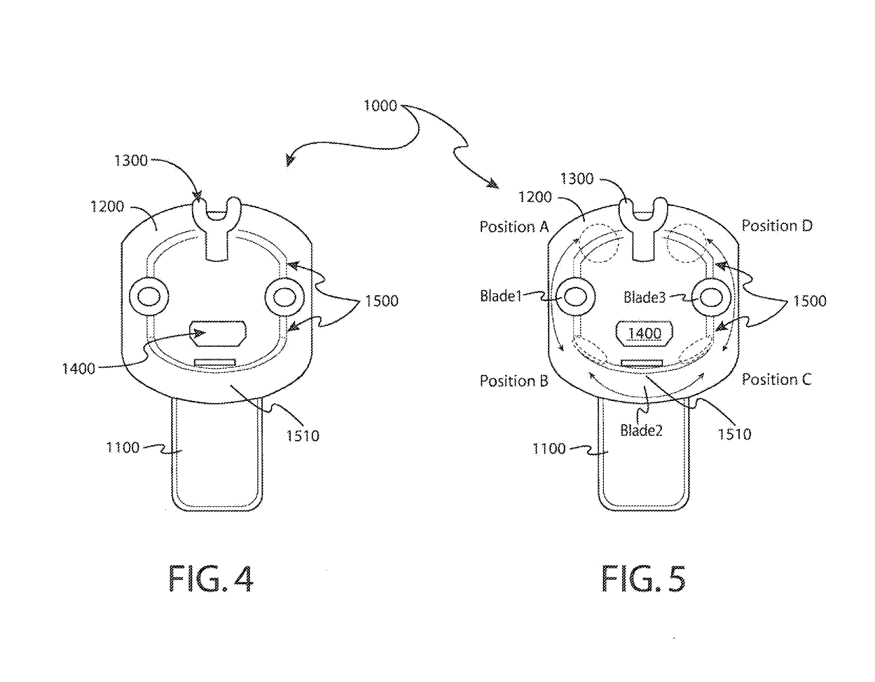

FIGS. 1A through 4 respectively depict a perspective view, a right side view, a front view, a left-side view, and a back view of a preferred beard styling apparatus 1000. Referring to said figures, the apparatus 1000 features: a handle 1100 with an internal motor (not shown); a canopy 1200; a nose guard 1300; a chin guard 1400; a spring mounted track 1500 with three spring mounted rotary blades 1510 that are movably secured to the track 1500. The canopy 1200 is preferably a firm yet slightly flexible structure (e.g., made from hard rubber or plastic like substances). In use, the canopy 1200 may encompass the cutting area of the device and, as discussed in greater detail below, is configured to sit stationary against the face of a user. Preferably, the canopy 1200 further houses (i) the nose guard 1300 so that the nose guard may support and align the apparatus to the nostrils and upper lip of a user, (ii) the chin guard 1400 for stabilizing and supporting the apparatus to the chin of the user, and (iii) the track 1500 that supports the rotary blades 1510, wherein the track 1500 is spring mounted and configured to define the outline of a beard style. Suitably, the spring mounted rotary blades 1510 are configured for compression against the face of a user during operation, wherein the blades are spring mounted so that the blades may be continually placed against the face of a user and wherein the track is spring mounted so that the blades may be aligned or adjusted to the contours of the user's face. As discussed in further detail below, the motor (not shown) is disposed within the handle 1100 and is coupled to the rotary blades 1510 to drive both the rotation of the rotary blades 1510 and movement of the same 1510 along the track 1500. Although not shown, motion of the rotary blades may be driven by, for instance, a series of gears with teeth, springs, and other mechanisms. Such coupling of the motor to the blades for rotational and track movement will be well known to those of skill art.

FIG. 5 is an operational display of the back view of the beard styling apparatus. More specifically, FIG. 5 is an illustration of a preferred mode of operation for the rotary blades 1510 of the apparatus, wherein each blade oscillates between two of four positions on the tracks. In one embodiment: a first rotary blade, Blade1, oscillates along the track 1500 between position A and B shown in broken lines; a second rotary blade, Blade2, oscillates along the track 1500 between positions B and C shown in broken lines; and a third rotary blade, Blade 3 oscillates along the track 1500 between positions C and D shown in broken lines. Suitably, the first, second and third blades Blade1, Blade2, Blade3 would be in sync such that: (a) the first blade is in position A while the second blade is in position B and the third blade is in position C; and (b) the first blade is in position B while the second blade is in position C and the third blade is in position D. While oscillating, it is contemplated that the blades 1510 are also rotating to cut facial hair passed over during said oscillations. In a preferred embodiment, the oscillations of the first through third blades overlap (e.g. B and C define overlapping positions). As discussed above, the motor (not shown) is configured to drive both the oscillations and rotation of the blades 1510.

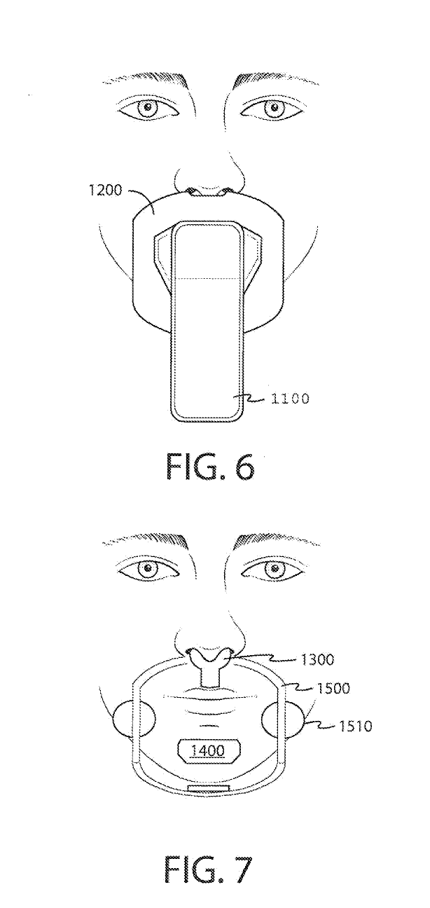

FIG. 6 is an environmental view of the beard styling apparatus 1000. Specifically, the figure illustrates the front view of the apparatus 1000 as it is preferably placed against the face of a user in the operating position. As discussed in greater detail below, once the apparatus 1000 is placed along the user's face, as shown, the apparatus 1000 preferably does not move after being turned on because the blades are moving internally relative to the user's face. To avoid any disruption in the beard style pattern created by the apparatus, the lips and mouth of the user should remain still while the apparatus 1000 is on.

FIG. 7 a schematic diagram showing the blades 1510 and a track 1500 being positioned on a face of a user. The figure illustrates how the tracks 1500 (guiderails) are preferably positioned when the apparatus 1000 is placed against the face of a user, in an operating position. The figure also shows how the nose guard 1300 and chin guard 1400 are preferably positioned along the face to stationarily stabilize the apparatus 1000 against the face. The apparatus must be aligned against the face (prior to turning the electric shaver on) with the nose guard positioned against the nostrils and upper lip indentation as indicated. More specifically, the chin guard 1400 may suitably be placed against the user's chin while the nose guard 1300 is positioned under the nostrils of the user's nose so as to center the apparatus 1000 and stabilize the same against the user's face. Once the chin and nose guards 1400, 1300 are so positioned, the apparatus 1000 may suitably remain stagnant, held in place by the individual's hand, and compressed against the user's face. After stabilization of the apparatus 1000, the apparatus can be turned on, allowing the oscillating blades to move along the tracks and cut facial hair automatically in their path.

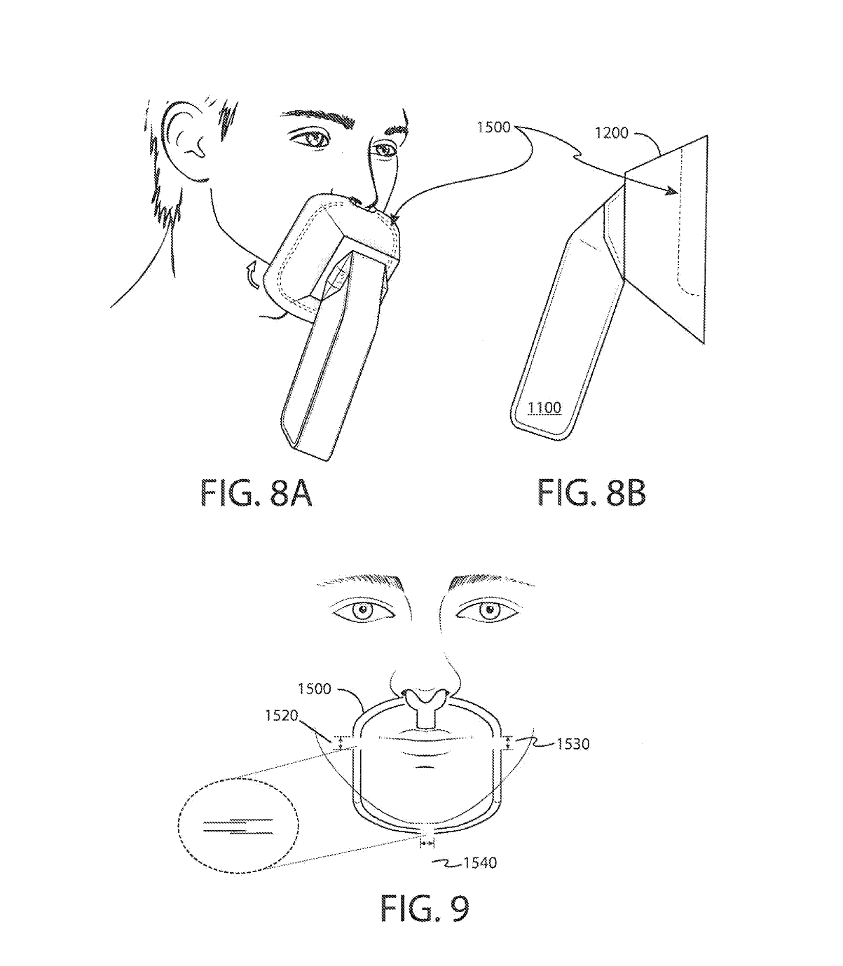

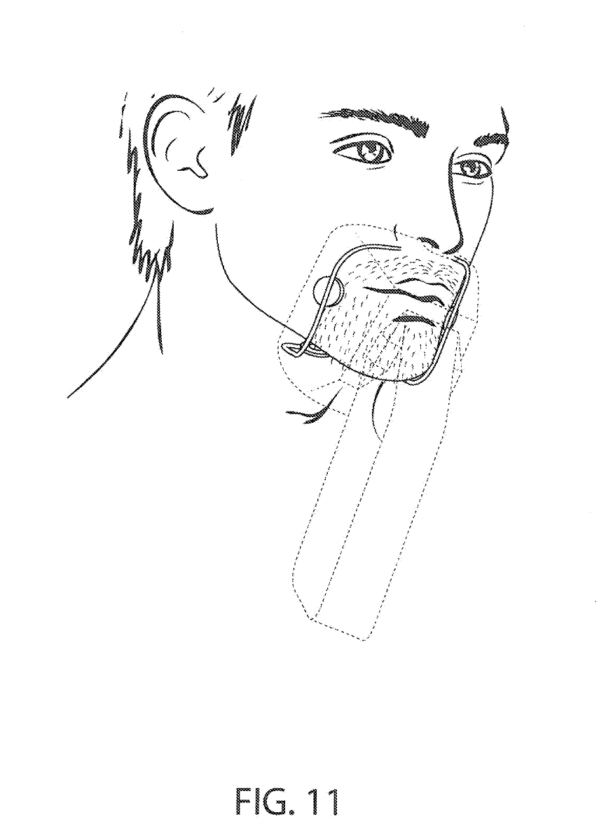

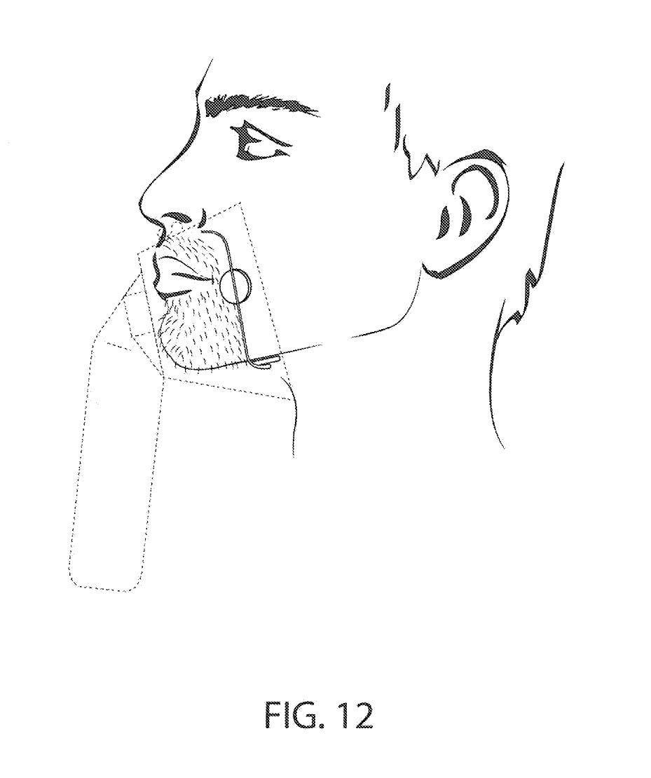

FIGS. 8A and 86 are another schematic diagram showing a track positioned on a face. As shown the track 1500 may be suitably formed or configured to bend or adjust to the contours of a face. FIGS. 11 and 12 further illustrate that, in the preferred embodiment, the track bends under the user's chin so that the blade may remain flush against the skin on the underside of the chin and according to the beard style pattern.

FIG. 9 is yet another schematic diagram showing a track positioned on a face. As shown, the track 1500 may suitably be widened and lengthened to fit the dimensions of a specific user's face. FIG. 9 illustrates how the tracks 1500 (guiderails) would be positioned when the apparatus is placed against the face, in the operating position. In a preferred embodiment, the track 1500 features three adjustment points, 1520, 1530, 1540 wherein sectioned rails of the track may slide relative to other rails to accomplish adjustment. In operation, the first two adjustment points 1520, 1530 (working in unison) are suitably for elongating the track 1500 while the third adjustment point 1540 is suitably for widening the track. Such elongation or widening of the track allow a user to adjust the track 1500 to the user's facial dimensions or beard style preferences. Suitably, the actual adjustment mechanism can be done in a number of ways, for example, using a threaded rotating screw-like mechanism to bring the guiderails closer together or further apart or a mechanism with latching teeth to allow for a number setting, clicking each latch to bring the guiderails closer or further apart, locking into the teeth.

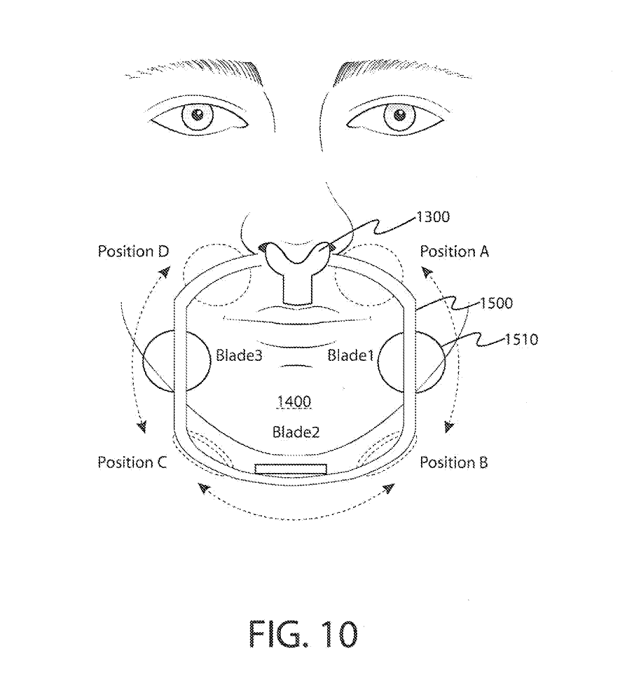

FIG. 10 is an operational and schematic view of blades and a track) positioned on a face. In operation: (1) the track 1500 may suitably be adjusted to the dimensions of the user's face or beard style preference; (2) the apparatus may be stationarily placed over the mouth area so that the nose guard is positioned beneath the nostrils of a user and so that the chin guard is placed (or cupped) against the user's chin; (2) the motor may be turned-on whereby the cutting mechanism(s) operate while traversing the track to shape the beard style; and (3) the motor may continue to run so that the cutting mechanism(s) may repeatedly move back and forth along the track until the beard style is completed. In a preferred mode of operation, the track may be adjusted to fit the contours and size of the user's face. In one embodiment, the nose and chin guards may be preferably spring-mounted and adjustable so that depth of the shape may be adjusted between a clean shave and various other facial hair lengths. In other embodiments, different cutting mechanisms, such as straight razors or lasers, may be utilized along the track.

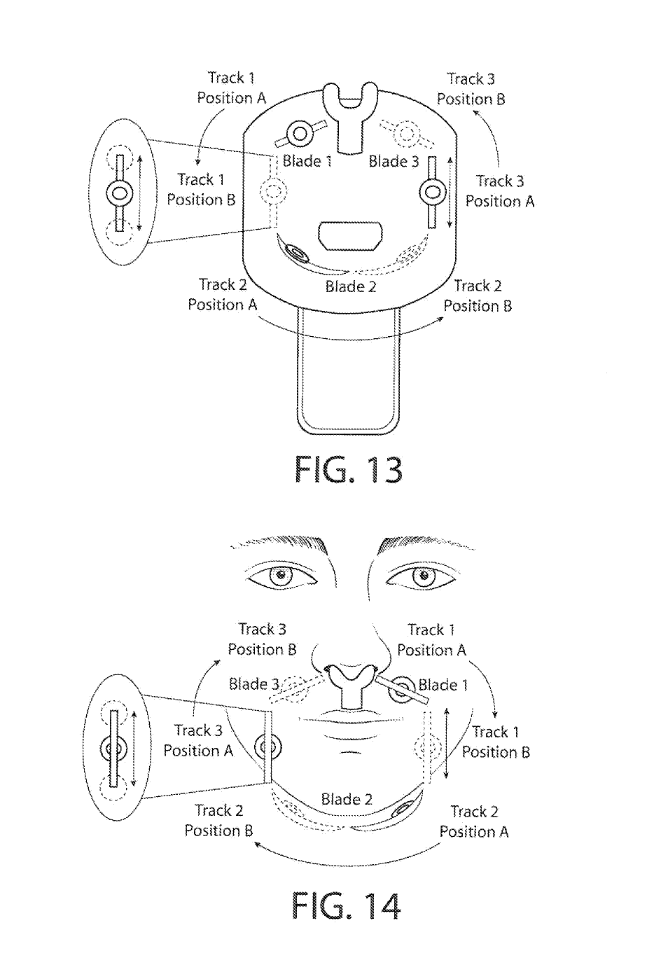

FIGS. 13 and 14 illustrate an alternate embodiment of the beard trimming apparatus. Generally, the depicted embodiment operates as disclosed above in connection with the earlier figures. However, the track 1500 is divided into three sections, respectively identified as track 1, 2 and 3. Suitably, the tracks move back-and-forth between positions A and B while the blades oscillate across the individual tracks (as shown in the blow-out view).

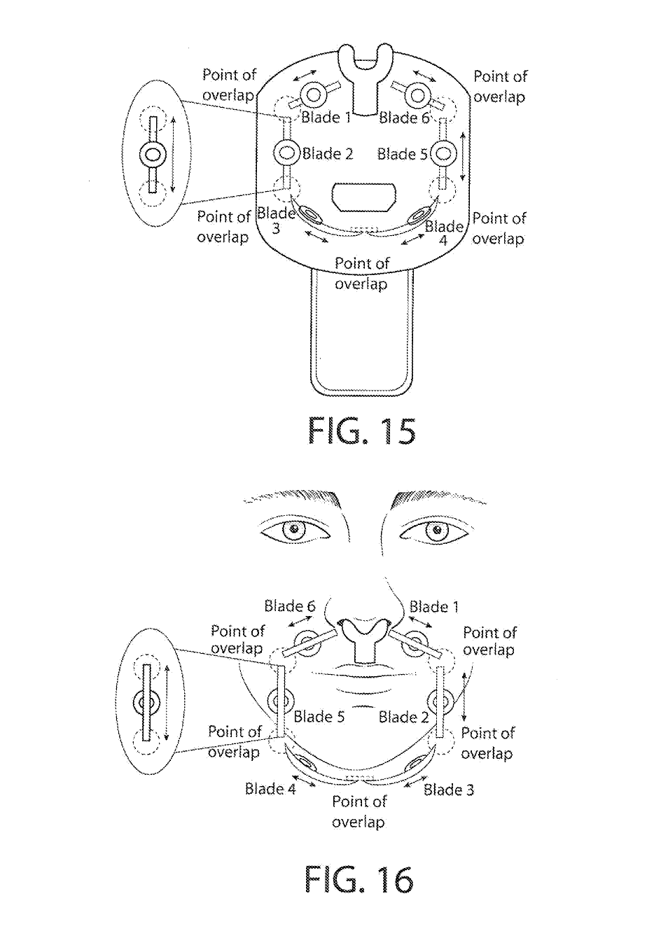

FIGS. 14 and 15 illustrate another alternate embodiment of the beard trimming apparatus. In general, the depicted embodiment operates like the earlier disclosed embodiments. However, the track is divided into six stationary sections. Suitably, the blades oscillate across their respective tracks. In a preferred embodiment, the oscillation of the blades may be synchronized so that the blade paths overlap to ensure the full beard pattern is cut into the facial hair of the user.

Other assembly methods may be practiced depending on the use of alternative embodiments described herein, and will be readily apparent to those skilled in the art.

I claim:

1. An apparatus comprising:
a canopy with a nose guard and chin guard;
at least one cutting mechanism disposed on a guiding means within the canopy, wherein the guiding means is configured to define the outline of a facial hair style; and
a motor for (a) operating the cutting mechanism(s) and (b) shifting the position of the cutting mechanism(s) around the guiding means.

2. The apparatus of claim 1, wherein the nose guard and the chin guard are positioned along a user's face to stabilize the apparatus during operation.

3. The apparatus of claim 1, wherein the canopy is configured to remain stationary against the face of a user during operation.

4. The apparatus of claim 1, wherein the guiding means is configurably adjusted to accommodate the shape of a user's face.

5. The apparatus of claim 4, wherein the guiding means is a track.

6. The apparatus of claim 5, wherein adjustment of said track is performed by widening or narrowing the width or length of the track.

7. The apparatus of claim 5, wherein the track bends under a user's chin so that the cutting mechanisms remain flush against the chin.

8. The apparatus of claim 1, wherein each cutting mechanism is configured to operate only within predetermined sections of the guiding means.

9. The apparatus of claim 1, wherein the cutting mechanisms consist of rotary blades.

10. The apparatus of claim 8, wherein the rotary blades are spring mounted.

11. The apparatus of claim 1, wherein the guiding means is spring mounted.

12. The apparatus of claim 1, further comprising three cutting mechanisms disposed on a track within the canopy.

13. The apparatus of claim 1, wherein the outline of the facial hair style is selected from any of the group consisting of beard, goatee, goatee sans mustache, chinstrap, chin strip, soul patch, mutton chops, balbo, mustache, handlebar mustache, scruff, trimmed scruff, chinless beard, door knocker, goatee with chin strap, chin curtain, French cut goatee, Fu Manchu, Horseshoe Mustache, neckbeard, pencil mustache, stubble, toothbrush mustache, and Van Dyke beard.

14. A shaving apparatus for shaving facial hair comprising:
a handle fixed to a canopy; and
said canopy featuring a guiding means therein where at least one cutting blade is disposed along said guiding means and configured for cutting preset facial hair patterns.

15. The shaving apparatus of claim 14, wherein the guiding means is a track.

16. A method of shaving facial hair comprising:
selecting a predetermined facial hair pattern;
placing an apparatus on a user's mouth area;
positioning the apparatus on specified portions of the mouth area;
cutting the selected facial hair pattern using cutting mechanisms disposed on a guiding means within a canopy in the apparatus; and
wherein the guiding means is configured to define the shape of the selected facial hair pattern.

17. The method of claim 16, wherein the specified portions of the mouth area are the nostrils, upper lip, and the chin.

18. The method of claim 16, wherein the cutting mechanism is a rotary blade.

19. The method of claim 16, wherein the guiding means is a track.

20. The method of claim 16, wherein the guiding means is configurably adjusted to accommodate the shape of a user's face.
